(19) United States
(12) Patent Application Publication
(10) Pub. No.: US 2005/0193780 A1
(43) Pub. Date: Sep. 8, 2005

(54) Apparatus and felt for embossing leather and artificial leather type textiles using high tension

(76) Inventor: Giancarlo Cassarino, Venice (IT)

Correspondence Address: FROMMER LAWRENCE & HAUG, 745 FIFTH AVENUE- 10TH FL., NEW YORK, NY, 10151, US

(21) Appl. No.: 10/791,484

(22) Filed: Mar. 2, 2004

(51) Int. Cl. C14B 1/00

(52) U.S. Cl. 69/1

(57) ABSTRACT

An embossing apparatus, similar to those used in the paper industry, for use in the leather industry to emboss leather and leather type textiles. The apparatus includes a rotating felt under tension. In a preferred embodiment, the felt wraps around a heated embossing cylinder under tension and there is no nip. In this case, the leather textile is conveyed while sandwiched between the felt and the cylinder and is thereby embossed.

### BACKGROUND OF THE INVENTION

1. Field of the Invention

The present invention relates to the leather and artificial leather type textile arts. More specifically, the present invention relates to an apparatus and felt for embossing leather textiles using tension. In this application, the term “leather textiles” refers to 1) natural leather subjected to a tanning process; or 2) artificial leather, such as textiles coated with polyurethane (PU) or polyvinyl chloride (PVC) resins, leather coated with PU resins, or artificial suedes produced by processes such as needle punching.

2. Description of the Prior Art

Leather tanning and finishing is the process of converting raw hides or skins into leather textiles. Hides and skins have the ability to absorb tannic acid and other chemicals that prevent them from decaying. FIG. 1 is a general flow diagram of the leather tanning and finishing process. The raw hides are “cured,” a process which involves salting and/or drying the hide once its been stripped from the animal.

The first steps, commonly referred to as the “beamhouse” operations 30, prepare the hides for tanning 40. The cured hides are trimmed and soaked to remove salt and other solids, and to restore moisture lost during curing. The hides are then fleshed to remove excess tissue and impart a uniform thickness. The hair is removed from the hides by soaking in a lime/water mixture to loosen the hairs and then mechanically removing the loosened hairs.

These prepared hides are now ready for the tanning operations 40. Tanning may be performed using either trivalent chromium salts or vegetable tannins extracted from specific tree barks. Chrome tanned leather is softer, more pliable, and quicker to produce than vegetable tanned leather. Chrome tanning is performed using a one-bath process that is based on the reaction between the hide and the chromium salt.

Following chrome tanning, the tanned leather is wrung (or sammied) to dry the hide. This process of removing excess water from a hide is known as dewatering. The tanning liquors and water baths used on the hides in the tanning process saturate the hide with moisture. The wringing process reduces this water content to about 55% and can be achieved by a variety of machines. Wringing machines typically consist of two large rolls, which squeeze excess moisture from the hide. Other common machines use a large mangle with felt covered rollers to press the hide.

These machines typically use large rubber covered squeeze rolls juxtaposed in close proximity to one another. Two felt belts pass between the squeeze rolls with a wet hide sandwiched in between. FIG. 2 is a side cross-sectional diagram of a conventional leather press having a center top roll 200 in contact at two short pressure points 240 (or nips) with two lower rolls 210. The top roll and the bottom rolls are contained within the rotating felt belts 220 and 230 respectively. The hides are fed between the rolls by the felt belts and excess water is squeezed out at the nips.

The more rolls that are in a press; the more press nips can be formed and the more efficient the press is in removing water from the hides. For example, one roll over two rolls produces two press nips (as shown in FIG. 2), whereas two rolls over three rolls produces four press nips. Another aspect of dewatering the hide is the width of the nip. The larger the roll diameter the wider the nip. The hardness of the roll cover also plays a part in the nip width. The softer the cover the wider the nip. Thus, machine size is a function of the number of rolls, the size of the rolls, and the roll cover material. However, more rolls typically means a higher cost machine.

Regardless of the number of rolls, the leather press must precisely control the pressure applied to the hides. Too much pressure on a saturated hide can rupture the grained (flowered) side as water mainly exits the hide in one direction, which is to the flesh side.

Further, the dewatering process is dependent on the efficiency of the belts in carrying the expelled water away from the hide. Hence, the leather press belt must be able to handle the amount of water being pressed from the leather hide during the wringing process.

After wringing, the tanning process may be repeated and/or dyes may be applied. The tanned hide is then oiled (i.e. fat liquoring) to replace natural oils lost during the tanning process. The leather is dried again, to a 10-20% water content, by one of several methods (air drying, drying in a toggling or pasting unit, vacuum drying, or high-frequency drying) and is ready for finishing 50.

The present invention relates to finishing processes 50 for leather textiles. Finishing processes 50 include, for example, conditioning, staking, dry milling, buffing, spray finishing, and plating. Leather textiles may be finished in a variety of ways including: buffing to produce a suede finish; lacquering to produce a glossy patent leather finish; and waxing, shellacking, or treating with pigments, dyes and resins to achieve a smooth colored finish.

Finishing processes 50 can also include embossing of the leather textiles. In this connection, the embossing process can be described as transforming a flat, or two dimensional, leather material into a three dimensional material. Presently, printing and embossing leather textiles is performed in a manner similar to that commonly used in the paper industry for increasing the volume of hygienic tissue paper, that is, by applying pressure to leather textiles conveyed on a felt between two rolls, one roll being flat (smooth) and the other roll being embossed. In this case, the leather textiles (“skin”) pass through the two cylinders driven by the felt, and the felt and skin are pressed together, which is similar to the action of a laminating machine. This technology has a large diffusion in the leather industry as a finishing process 50.

In another method for embossing leather, a plate press is used. This is a press comprising two plates, one of which is embossed, and the other plate being flat and covered with a felt pad. In this method, the skin is placed on one plate and pressed with the other. This is considered a “discontinuous” process for embossing leather.

The term “artificial leather” encompasses all types of synthetic material that are similar to and have the same use as natural leather. There are several different processes for producing artificial leather. In one method, the skin is split into two different layers after the tanning process. One of these layers is called the “flower” and is used for a first quality product. The other layer is termed the “crust” and is used for a second quality product, or as the interior of shoes. One way to add value to this secondary product is to spray the layer with polyurethane resins so to simulate the first quality skin. This enhanced product can then be embossed as a normal skin.

In another method for making artificial leather, discarded materials from the tanning process are chopped, fine ground, mixed with resins and treated in a pulper, and refined. This is similar to a method for producing paper, and in this way it is possible to produce a material very similar to natural leather. This material can be painted and can be embossed as a natural skin. In yet another method, a conventional plastic film is embossed as a skin on the same material.

While some of the foregoing methods have certain attendant advantages, further improvements and/or alternative forms, are always desirable.

### SUMMARY OF THE INVENTION

The present invention is an apparatus and felt for embossing leather textiles. More specifically, the present invention is a leather-embossing apparatus that includes a felt or other textile belt under tension. In one embodiment of the invention, the embossing apparatus has first and second rolls, and a tension roll. A heated embossing roll is also provided and is operable to have the leather textiles wrapped around a portion thereof. The felt under tension is wrapped around a portion of the tension roll and the first and second rolls, and over the leather textiles wrapped around the embossing roll. The leather textiles are conveyed around the embossing roll between the felt belt and the embossing roll so as to be embossed. In this embodiment, the first and second rolls, the tension roll, and the embossing roll are arranged so as to not form a nip between any two rolls. The felt has a high thermal, chemical and mechanical resistance, and can be permeable to fluid.

The present invention will now be described in more complete detail with frequent reference being made to the figures, which are identified below.

### BRIEF DESCRIPTION OF THE DRAWINGS

For a more complete understanding of the invention, reference is made to the following description and accompanying drawings, in which:

FIG. 1 is a flow diagram of the leather tanning and finishing process;

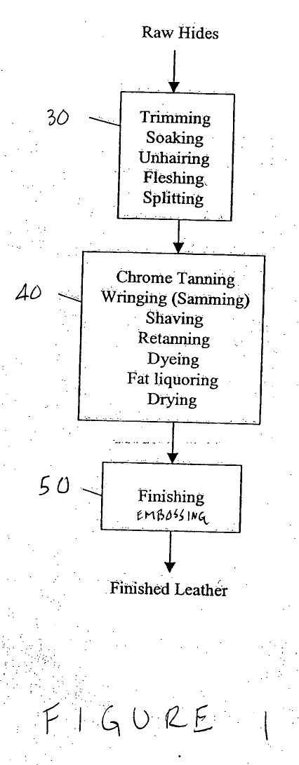

FIG. 2 is a side view of a leather press which includes a conventional felt; and

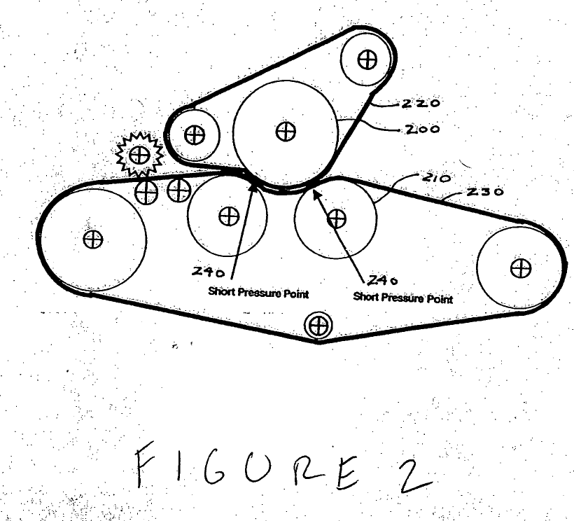

FIG. 3 is a side view of an apparatus for embossing leather textiles, according to an embodiment of the present invention.

### DETAILED DESCRIPTION OF THE PREFERRED EMBODIMENTS

In this application, the term “leather textiles” refers to 1) natural leather subjected to a tanning process; or 2) artificial leather, such as textiles or a layer of hide coated with polyurethane (PU) or polyvinyl chloride (PVC) resins, leather coated with PU resins, or artificial suedes produced by processes such as needle punching.

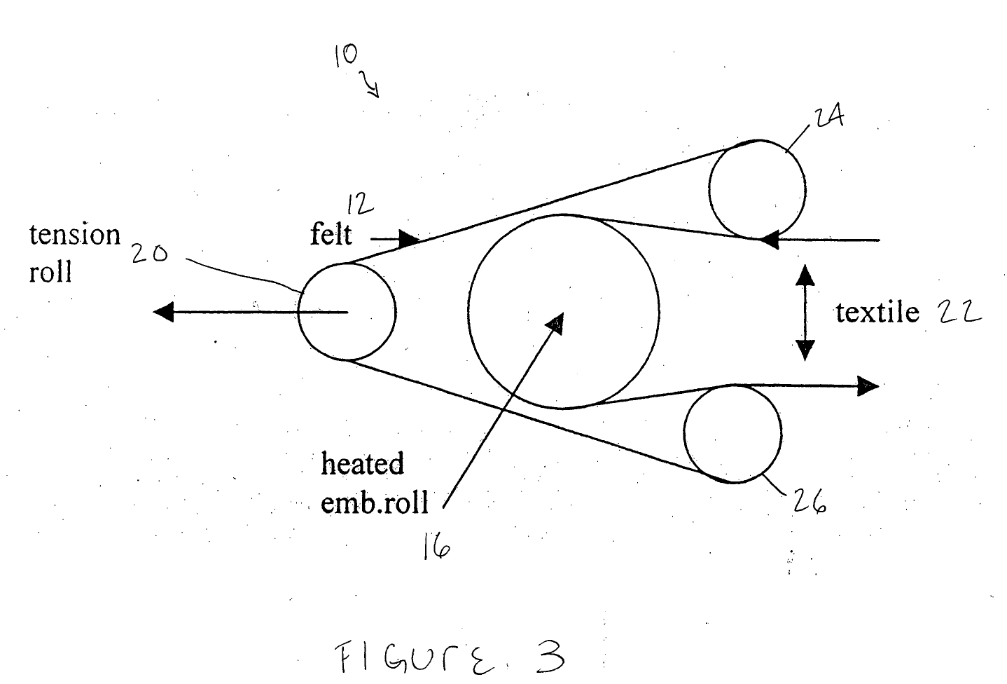

Turning now more particularly to the drawings, FIG. 3 is a side view of an embodiment of the apparatus 10 for embossing leather textiles 22, in accordance with the present invention. Advantageously, the apparatus 10 includes a rotating felt belt 12 which is under tension. In this connection, it is noted that a preferred embodiment of the invention includes a felt belt under tension, for example, in the range of 10-500 N/mm.

In addition to the felt belt 12, the leather-embossing apparatus 10 further includes a first roll 24, a second roll 26, a heated embossing roll 16, and a tension roll 20. In the preferred embodiment shown, these rolls 16, 20, 24, 26 each have a cylindrical shape, and are arranged so as to not to form a nip between any two rolls 16, 20, 24, 26.

As mentioned, the felt belt 12 rotates under tension, and generally takes the form of an endless loop having an inner surface, an outer surface, a longitudinal direction and a transverse direction. As FIG. 3 illustrates, the embossing roll 16 is operable to have the leather textiles 22 wrapped around a portion thereof. In this connection, the rotating felt belt 12 wraps around a portion of the tension roll 20 and the first and second rolls 24, 26, and over the leather textiles 22 wrapped around the embossing roll 16. In this way, the apparatus 10 enables the leather textiles 22 to be conveyed around the embossing roll 16 sandwiched between the felt belt 12 and the embossing roll 16 so as to be embossed. In this connection, either the embossing roll 16, the felt belt 12, or both, can be used as the texturing medium.

Referring further to FIG. 3, it is noted that the leather textiles 22 which are to be embossed can be treated with chemicals in order to achieve a desired effect. In this connection, the inventive felt belt 12 can be permeable to fluid and highly resistant to chemicals. It is further noted that the felt belt 12 has a high thermal resistance, so to withstand degradation at normal operating temperatures up to 120 degrees Celsius. Further, the felt belt 12 of the invention is made to resist mechanical stresses incurred during operation of the apparatus 10.

As described above, the use of the apparatus 10 and felt belt 12 in the leather finishing process will provide stability of the embossing effect. In addition, the inventive apparatus 10 and felt belt 12 shown in FIG. 3 provide the advantage of allowing higher temperatures for treatment of the leather textiles 22. The apparatus 10 and felt belt 12 of the invention also provide for speedier treatment of the leather textiles 22 due to higher heat transmission, compared with a prior art system for embossing using plates in a platen press.

Thus by the present invention its objects and advantages are realized, and although preferred embodiments have been disclosed and described in detail herein, its scope and objects should not be limited thereby; rather its scope should be determined by that of the appended claims.

1. An apparatus for use in a leather industry for embossing leather textiles, said apparatus comprising:
first and second rolls;
a heated embossing roll operable to have the leather textiles wrapped around at least a portion thereof;
a tension roll; and
a felt belt operable to be wrapped around at least a portion of the tension roll and the first and second rolls, and over the leather textiles wrapped around the embossing roll, the felt belt being under tension in the range of 10-500 N/mm,
wherein said apparatus is operable to enable the leather textiles to be conveyed around the embossing roll between the felt belt and the embossing roll so as to be embossed.

2. The apparatus of claim 1, wherein the first and second rolls, the tension roll, and the embossing roll are arranged so as to not to form a nip between any two rolls.

3. The apparatus of claim 1, wherein each of the first and second rolls, the embossing roll, and the tension roll has a cylindrical shape.

4. The apparatus of claim 1, wherein the felt belt has a high thermal, chemical and mechanical resistance, and is permeable to fluid.

5. The apparatus of claim 1, wherein either the embossing roll, the felt belt, or both, is used as a texturing medium.

6. The apparatus of claim 1, wherein the leather textiles are either natural leather and/or artificial leather.

7. The apparatus of claim 6, wherein the artificial leather comprises textiles or a layer of hide coated with polyurethane (PU) or polyvinyl chloride (PVC) resins, leather coated with PU resins, or artificial suedes produced by needle punching.

8. A felt belt for embossing leather textiles and usuable in an arrangement of first and second rolls; a heated embossing roll operable to have the leather textiles wrapped around at least a portion thereof; and a tension roll;
wherein the felt belt is wrapped around at least a portion of the tension roll and the first and second rolls, and over the leather textiles wrapped around the embossing roll, the felt belt being under tension in the range of 10-500 N/mm; and the leather textiles are conveyed around the embossing roll between the felt belt and the embossing roll so as to be embossed.

9. The felt belt of claim 8, wherein the belt has a high thermal, chemical and mechanical resistance, and is permeable to fluid.

10. The felt belt of claim 8, wherein either the embossing roll, the felt belt, or both, are used as a texturing medium.

11. The felt belt of claim 8, wherein either the leather textiles are either natural leather and/or artificial leather.

12. The felt belt of claim 11, wherein the artificial leather comprises textiles or a layer of hide coated with polyurethane (PU) or polyvinyl chloride (PVC) resins, leather coated with PU resins, or artificial suedes produced by needle punching.
